(19) United States
(12) Patent Application Publication
(10) Pub. No.: US 2024/0126276 A1
(43) Pub. Date: Apr. 18, 2024

(54) FLIGHT SPEAKER, OUTPUT POSITION IDENTIFICATION METHOD, AND NON-TRANSITORY COMPUTER READABLE MEDIUM

(71) Applicant: Roland Corporation, Shizuoka (JP)

(72) Inventors: Takahiro Murai, Shizuoka (JP); Keigo Tsutaki, Shizuoka (JP)

(73) Assignee: Roland Corporation, Shizuoka (JP)

(21) Appl. No.: 18/480,496

(22) Filed: Oct. 3, 2023

(30) Foreign Application Priority Data
Oct. 14, 2022 (JP) 2022-165562

(51) Int. Cl. G05D 1/10; B64U 10/30; H04R 1/02; H04S 7/00

(52) U.S. Cl. CPC G05D 1/106; B64U 10/30; H04R 1/028; H04S 7/30; B64U 2101/70; H04S 2400/15

(57) ABSTRACT

A flight speaker 1 firstly outputs an inspection sound while flying on a first route R1 in a linear shape connecting a position of a sound collecting microphone M disposed inside a concert hall P1, and identifies an optimal volume position where a volume of a received sound collected by the sound collecting microphone M becomes an expected volume. The flight speaker 1 outputs an inspection sound while flying on a second route R2 in an arc shape with a distance between the identified optimal volume position and a position of the sound collecting microphone M as a diameter, and identifies an output position where a sound waveform of the received sound from the sound collecting microphone M becomes an expected sound waveform.

### CROSS-REFERENCE TO RELATED APPLICATION

This application claims the priority benefit of Japan application serial No. 2022-165562, filed on Oct. 14, 2022. The entirety of the above-mentioned patent application is hereby incorporated by reference herein and made a part of this specification.

### BACKGROUND

### Technical Field

The invention relates to a flight speaker, an output position identification method, and a non-transitory computer readable medium.

### Description of Related Art

Patent Document 1 discloses a technology for flying a drone so as to set a position of a listener in a residential space 150 as a “hot spot” at which a desired sound quality is obtained through a sound output by a drone deployed speaker (referred to as “drone” in the following). Specifically, the drone collects sensor data 332 reflecting a geometric shape of the residential space 150, and creates a space model 334 in the residential space 150 based on such sensor data 332. A flight plan 364 is created based on the created space model 334. Accordingly, the drone can be arranged to fly to a position (referred to as “output position” in the following) where the hot spot is formed without the listener manually operating the drone.

### PRIOR ART DOCUMENT(S)

### Patent Document(s)

[Patent Document 1] U.S. Pat. No. 10,377,486

However, in order to create the flight plan 364, the sensor data 332 need to include the geometric shape of the entirety of the residential space 150 and the position of the listener. Therefore, there is an issue that, when the drone flies to the output position, it is required to fly all over the residential space 150 to collect the sensor data 332 in advance and create the space model 334 from the huge amount of the collected sensor data 332.

The invention provides a flight speaker capable of adaptively identifying an output position outputting sounds, an output position identification method, and an output position identification program.

### SUMMARY

A flight speaker according to an aspect of the invention includes: a flight part; a sound output part, outputting a sound; a searching flight part, performing a searching flight in which an inspection sound is output from the sound output part while performing a flight of a predetermined flight route using the flight part; and an identification part, in a case where a determination is made that sound information at a time of observing, by using an input part disposed at a predetermined position, the inspection sound output in the searching flight using the searching flight part satisfies a predetermined condition, identifying an output position that is a position where the sound is output from the sound output part based on a position where the inspection sound corresponding to the determination is output.

An output position identification method according to another aspect of the invention is executed by a flight speaker including a flight part and a sound output part outputting a sound. The output position identification method includes: a searching flight step of performing a searching flight in which an inspection sound is output from the sound output part while performing a flight of a predetermined flight route using the flight part; and an identification step, in a case where a determination is made that sound information at a time of observing, by using an input part disposed at a predetermined position, the inspection sound output in the searching flight using the searching flight step satisfies a predetermined condition, identifying an output position that is a position where the sound is output from the sound output part based on a position where the inspection sound corresponding to the determination is output.

A non-transitory computer readable medium according to yet another aspect of the invention stores an output position identification program. The output position identification program causes a computer including a flight part and a sound output part outputting a sound to execute a process for identifying an output position that is a position where the sound is output from the sound output part. The computer is caused to execute: a searching flight step of performing a searching flight in which an inspection sound is output from the sound output part while performing a flight of a predetermined flight route using the flight part; and an identification step, in a case where a determination is made that sound information at a time of observing, by using an input part disposed at a predetermined position, the inspection sound output in the searching flight using the searching flight step satisfies a predetermined condition, identifying an output position that is a position where the sound is output from the sound output part based on a position where the inspection sound corresponding to the determination is output.

### BRIEF DESCRIPTION OF THE DRAWINGS

FIG. 1 is a schematic view illustrating a concert hall in which a flight speaker and an electronic musical instrument are disposed.

FIG. 2A is a side view of the flight speaker, and FIG. 2B is a bottom view of the flight speaker in the direction of an arrow sign IIb.

FIG. 3A is a view illustrating a volume searching flight, and FIG. 3B is a sound quality searching flight.

FIG. 4 is a functional block diagram of the flight speaker.

FIG. 5 is a block diagram illustrating an electrical configuration of the flight speaker and the electronic musical instrument.

FIG. 6A is a flowchart illustrating a main process of the flight speaker, and FIG. 6B is a flowchart illustrating a searching process of the flight speaker.

FIG. 7 is a flowchart illustrating an output position searching process of the flight speaker.

FIG. 8A is a flowchart illustrating a main process of the electronic musical instrument, and FIG. 8B is a flowchart illustrating a DSP process of the electronic musical instrument.

FIG. 9A is a view illustrating a volume searching flight in a modified example, and FIG. 9B is a sound quality searching flight in another modified example.

FIG. 10 is a flowchart illustrating an output position searching process in a modified example.

### DESCRIPTION OF THE EMBODIMENTS

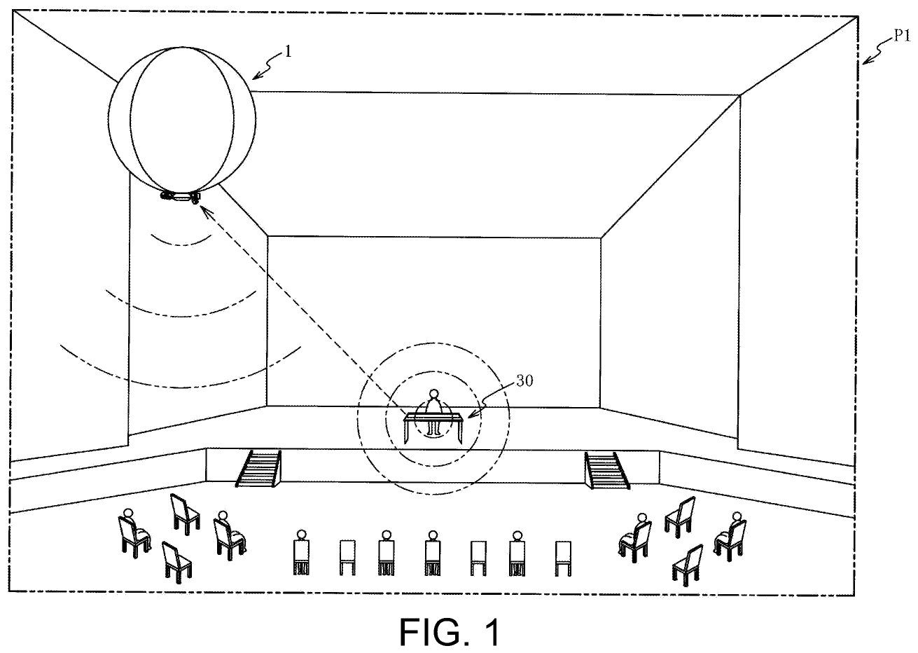

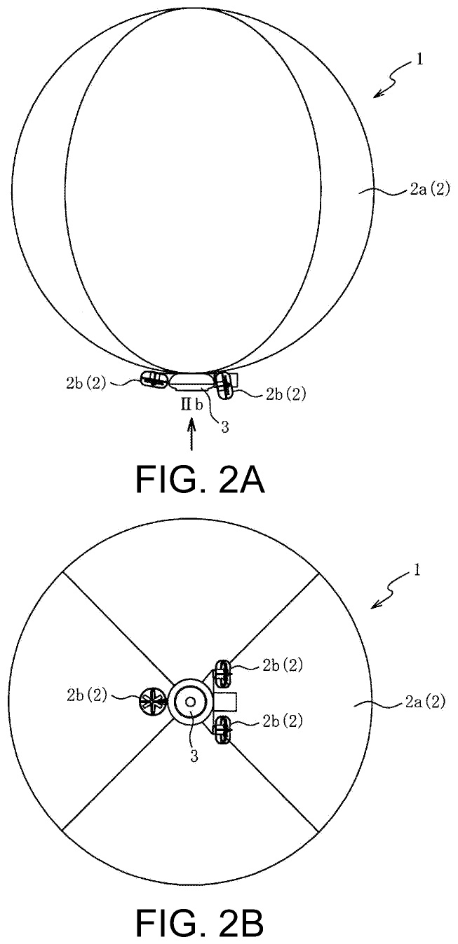

In the following, the exemplary embodiments will be described with reference to the drawings. The outline of a flight speaker 1 according to the embodiment is described with reference to FIG. 1 and FIGS. 2A and 2B. FIG. 1 is a schematic view illustrating a concert hall P1 in which the flight speaker 1 and an electronic musical instrument 30 are disposed. In the concert hall P1, the flight speaker 1 and the electronic musical instrument 30 outputting musical sounds through the performance of a user are disposed. The flight speaker 1 is a device that outputs ambience sounds that are sounds corresponding to the musical sounds output by the electronic musical instrument 30. The flight speaker 1 is configured to be able to fly, and is disposed above the audience seats in the concert hall P1. A specific configuration of the flight speaker 1 is described with reference to FIGS. 2A and 2B.

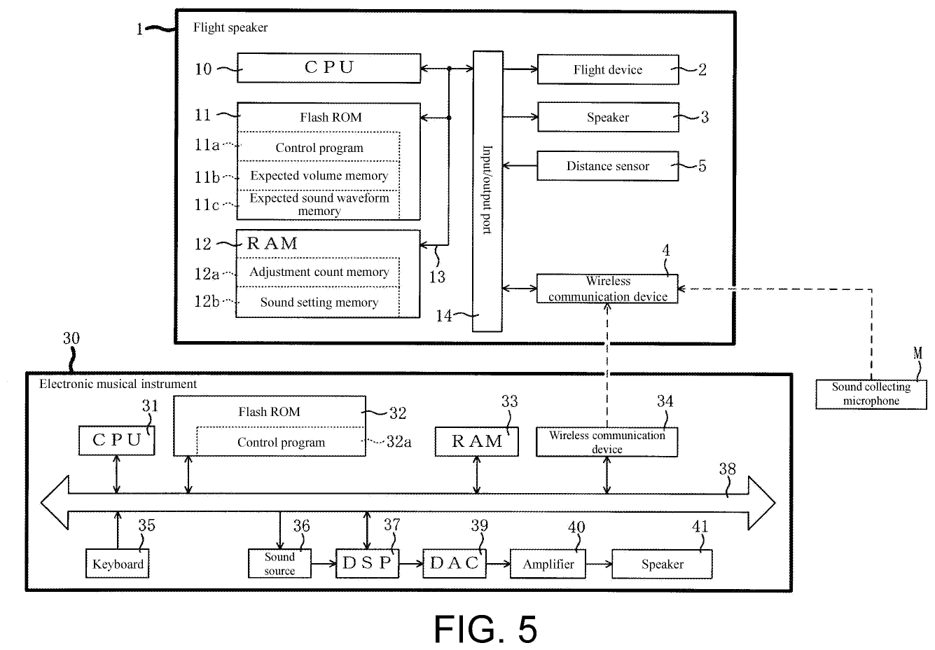

FIG. 2A is a side view of the flight speaker 1, and FIG. 2B is a bottom view of the flight speaker 1 in the direction of an arrow sign IIb. The flight speaker 1 includes a flight device 2 and a speaker 3, a wireless communication device 4 and a distance sensor 5 (see FIG. 5 for all of them). The flight device 2 is a device that allows the flight speaker 1 to fly, and is formed by a balloon 2a provided at the upper part of the flight speaker 1 and a propeller 2b provided at the lower part of the flight speaker 1.

The balloon 2a is formed by a balloon filled with helium gas. The size and the shape

of the balloon 2a are arranged to the extent that, in the case where the flight speaker 1 stops the rotation of the propeller 2b, the altitude when the rotation of the propeller 2b is stopped can be maintained by utilizing the buoyancy of the balloon 2a (that is, the flight speaker 1 neither ascends or descends). The balloon 2a is not limited to being filled with helium gas, and may also be filled with gas having a specific gravity lower than air (atmosphere), such as hydrogen, for example.

Three propellers 2b are provided on the bottom surface of the balloon 2a. The propellers 2b are configured so that the respective orientations thereof can be changed. By arbitrarily adjusting the orientations of the propellers 2b and rotating the propellers 2b by using a motor (not shown) connected with the propellers 2b, the flight speaker 1 can fly in a predetermined flight direction. The three propellers 2b form a drone. That is, the flight device 2 of the embodiment is realized by a “silent drone” formed by the balloon 2a and the drone formed by the propellers 2b.

The flight speaker 1 flies, by using the propellers 2b, to an output position (to be described afterwards) where the ambience sound is output, and is maintained at the output position by utilizing the buoyancy of the balloon 2a even if the propellers 2b are stopped. Accordingly, since the noise of the rotation of the propellers 2b can be suppressed from being mixed with the output ambience sounds, the audience in the concert hall P1 can hear appropriate ambience sounds.

The speaker 3 is an output device that outputs sounds. The speaker 3 is provided among the three propellers at the bottom of the balloon 2a, and the portion outputting sounds in the speaker 3 faces downward (i.e., toward the bottom of the paper surface in FIG. 2A). With the speaker 3 facing downward, the audience of the concert hall P1 located below the flight speaker 1 can sufficiently hear the sounds output from the speaker 3.

The wireless communication device 4 is a device performing wireless communication with an external machine. The ambience sound transmitted from the electronic musical instrument 30 via wireless communication is received by the wireless communication device 4, and the received ambience sound is output from the speaker 3.

The distance sensor 5 is a device that obtains distances with objects around the flight speaker 1. In the embodiment, a light detection and ranging (LIDAR) is used as the distance sensor 5. However, other devices capable of obtaining distances with objects in the surrounding, such as a millimeter-wave radar, an ultrasonic radar, a stereo camera, etc., may also be used as the distance sensor 5. The distance sensor 5 of the embodiment is formed to be able to obtain the distance and the direction with respect to an identification marker having a specific shape (e.g., a star shape).

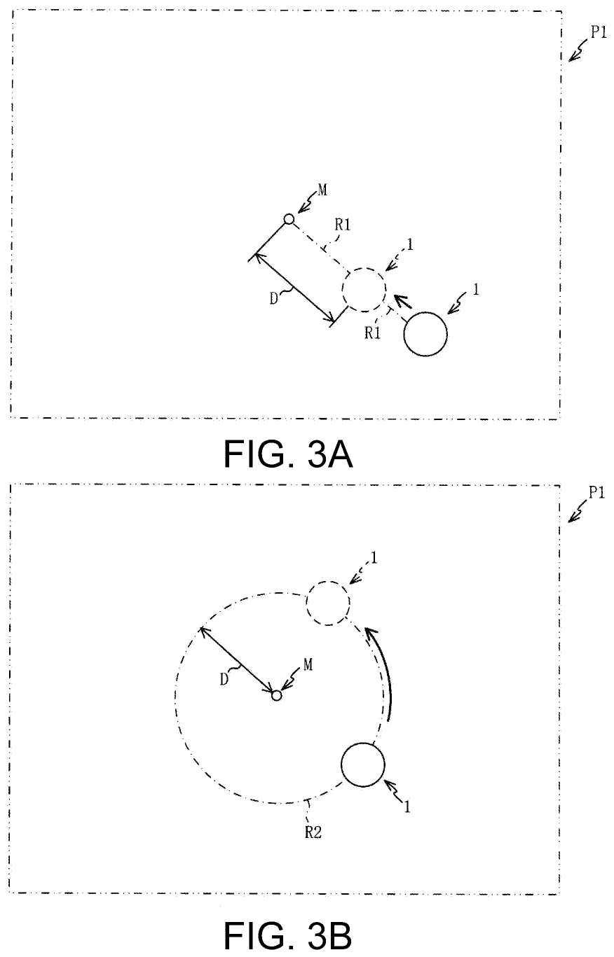

Specifically, the identification marker is attached to a sound collecting microphone M (see FIG. 3), and when it is determined that the identification maker is included in the detection range of the distance sensor 5, the distance between the distance sensor 5 and the identification marker and the direction of the identification marker when viewed from the distance sensor 5 are output. Accordingly, the distance from the flight speaker 1 to the sound collecting microphone M and the direction of the sound collecting microphone M when viewed from the flight speaker 1 are obtained.

Here, the ambience sound output from the speaker 3 is described. The ambience sound of the embodiment is a sound including, among the components of a musical sound such as a piano sound, etc., output by the electronic musical instrument 30, a reverberation component related to reverberation, and a specific frequency component in the musical sound (e.g., a frequency component of a specific higher harmonic of a sound produced by operating a key of a keyboard 35 (FIG. 5) of the electronic musical instrument 30). Specifically, the reverberation component is a sound component obtained by reflecting the sound of an actual musical instrument recorded in the musical sound output by the electronic musical instrument 30 on a structure of a wall surface, a ceiling, an audience seat, etc., of the concert hall P1. The reverberation component is also expressed as reverberation, delay, or echo.

When an actual musical instrument is played in a performance venue, such reverberation component spreads in the performance venue in addition to the sound produced by playing the musical instrument. Therefore, the listener can feel the spaciousness with respect to the sound of the musical instrument that is played. Meanwhile, although the reverberation component is included in the musical sound output by the electronic musical instrument 30, the reverberation component is drowned out in the sound of the actual musical instrument output from the electronic musical instrument 30 at the same time with the reverberation component, and the reverberation component heard by the listener of the musical sound is poor.

Therefore, in the embodiment, the ambience sound is output from the flight speaker 1 disposed above the audience seats of the concert hall P1 together with the musical sound output by the electronic musical instrument 30. Accordingly, since the reverberation component included in the ambience sound is output to the audience seats from above the audience seats in addition to the musical sound output by the electronic musical instrument 30, the audience can sufficiently perceive the reverberation component and feel the spaciousness in the musical sound output by the electronic musical instrument 30.

In addition, the ambience sound includes a specific frequency component in the musical sound output by the electronic musical instrument 30 together with the reverberation component. With such specific frequency component, the reverberation component can be made more harmonious with the musical sound output by the electronic musical instrument 30.

Accordingly, since in the musical sound output by the electronic musical instrument 30, the reverberation component which is poor compared to the musical sound output from the actual musical instrument can be compensated with the ambience sound, the audience in the audience seats can hear a sound that is realistic and faithfully reproduces the sound transmission condition of the actual musical instrument.

In order to effectively transmit such ambience sound to the audience seats, the flight speaker 1 needs to be properly arranged in the concert hall P1. Referring to FIGS. 3A and 3B, a means for identifying the output position of the flight speaker 1, which is a position where the ambience sound is effectively transmitted to the audience seats, is described.

FIG. 3A is a view illustrating a volume searching flight. At the time of disposing the flight speaker 1 in the concert hall P1, the sound collecting microphone M is firstly disposed in the concert hall P1. The sound collecting microphone M is a device transmitting a collected sound to another machine through wireless transmission. Although the embodiment shows that the position where the sound collecting microphone M is disposed above the audience seats that are most frequently seated in the concert hall P1, such position may be an arbitrary place in the concert hall P1. In addition, the identification marker is attached to the sound collecting microphone M.

In the identification of the output position, a predetermined inspection sound is output from the speaker 3 of the flight speaker 1. The inspection sound in the embodiment is formed by white noise. The inspection sound output from the flight speaker 1 is collected by the sound collecting microphone M, and the collected sound is transmitted to the flight speaker 1 via wireless communication. Based on the sound (referred to as “received sound” in the following) collected by using the sound collecting microphone M received by the wireless communication device 4 of the flight speaker 1, the output position of the flight speaker 1 where an appropriate ambience sound can be heard at the position of the sound collecting microphone M is identified by moving the flight speaker 1.

In the identification of the specific output position, firstly, the flight speaker 1 flies in a random flight direction while the output of the inspection sound from the flight speaker 1, the sound collection of such inspection sound by the sound collecting microphone M, and the sound transmission from the sound collecting microphone M to the flight speaker 1 are performed. By comparing the position change through the random flight and the change of the volume of the received sound from the sound collecting microphone, multiple directions in which the volume of the received sound increases are extracted.

In addition, by summarizing the extracted directions in which the volume increases, the input position, which is the position of the sound collecting microphone M, is estimated. Accordingly, the user can grasp the current position of the sound collecting microphone M disposed in the concert hall P1 without setting the position of the sound collecting microphone M in the flight speaker 1 in advance.

After the input position is estimated, a searching flight in which the flight speaker 1 flies to the output position is performed. Firstly, a volume searching flight which verifies the volume of the received sound from the sound collecting microphone M and searches for a position where such volume becomes an expected volume (e.g., 70 dB) that is a predetermined volume is performed while the flight speaker 1 flies in a direction approaching the estimated input position or in a direction leaving the estimated input position.

Specifically, as shown in FIG. 3A, in the volume searching flight, a first route R1 as a flight route of the flight speaker 1 is formed. The flight route R1 is a linear route when viewed from the top of the concert hall P1 and connects the current position of the flight speaker 1 and the estimated input position. The angle of the first route R1 is set to conform to the direction of the sound collecting microphone M viewed from the flight speaker 1 and obtained by the distance sensor 5. In addition, when it is determined that the volume of the received sound from the sound collecting microphone M at the current position of the flight speaker 1 is higher than the expected volume, the flight speaker 1 is arranged to fly in the direction of the position of the sound collecting microphone M along the first route R1, that is, the flight speaker 1 is arranged to fly in the direction of leaving the sound collecting microphone M.

Meanwhile, when it is determined that the volume of the received sound from the sound collecting microphone M at the current position of the flight speaker 1 is lower than a predetermined volume, the flight speaker 1 is arranged to fly in a direction opposite to the position of the sound collecting microphone M along the first route R1, that is, the flight speaker 1 is arranged to fly in the direction approaching the sound collecting microphone M. In the volume searching flight, the flight direction of the flight speaker 1 is adjusted to conform to the direction of the sound collecting microphone M viewed from the flight speaker 1 and obtained by the distance sensor 5, so that the flight speaker 1 can fly along the first route R1.

By repeating such volume searching flight, an optimal volume position where the volume of the received sound from the sound collecting microphone M becomes the predetermined volume is identified. The identified optimal volume position is a position where the ambience sound output from the flight speaker 1 disposed at such position can be heard at an appropriate volume with the sound collecting microphone M.

Following such volume searching flight, a sound quality flight which verifies the sound quality of the received sound from the sound collecting microphone M and searches for a position where such sound quality becomes a predetermined sound quality is performed while the flight speaker 1 flies while maintaining a distance D between the estimated input position (position of the sound collecting microphone M) and the identified optimal volume position. The distance D is obtained by using the distance between the flight speaker 1 and the sound collecting microphone M obtained by the distance sensor 5 at the time when the flight speaker 1 is disposed at the optimal volume position.

FIG. 3B is a view illustrating a sound quality searching flight. Specifically, in the sound quality searching flight, a second route R2 as a flight route of the flight speaker is formed. The second route R2 is an arc-shaped route when viewed from the top of the concert hall P1, in which the input position is set as the center, and the distance D between such input position and the optimal volume position identified in the volume searching flight is set as the diameter. In addition, the sound quality of the received sound from the sound collecting microphone M is determined while the flight speaker 1 is arranged to fly along the second route R2 that is formed. In the sound quality searching flight, the flight direction of the flight speaker 1 is adjusted to be orthogonal to the direction of the sound collecting microphone M viewed from the flight speaker 1 and obtained by the distance sensor 5, so that the flight speaker 1 can fly along the second route R2.

In the embodiment, the sound quality is determined based on the difference between an actual sound waveform which is the waveform of the received sound from the sound collecting microphone M and an expected sound waveform which is an expected sound waveform of the sound collected by the sound collecting microphone M. That is, if the difference between the sound waveform of the received sound from the sound collecting microphone M and the expected sound waveform is small, the received sound is determined to have a “good” sound quality, and if the difference between the sound waveform of the received sound from the sound collecting microphone M and the expected sound waveform is large, the received sound is determined to have a “poor” sound quality.

The flight speaker 1 outputs an inspection sound from the speaker 3 during the flight along the second route R2, and, by further determining the sound quality of the received sound received from the sound collecting microphone M, the position of the flight speaker 1 where the waveform of the received sound from the sound collecting microphone M is equal to the expected sound waveform is identified. Such identified position is set as the output position. The ambience sound output from the flight speaker 1 disposed at the identified output position can be heard at an appropriate sound quality with the sound collecting microphone M.

Here, with the second route R2 being formed in an arc shape with the estimated input position as the center, each position that the flight speaker 1 flies in the sound quality searching flight is a position spaced apart from the estimated input position by the distance D, like the optimal volume position. Accordingly, the volume of the received sound received from the sound collecting microphone M can be equal to the volume of the received sound received at the optimal volume position. Accordingly, at the output position identified through the sound quality searching flight, the sound quality of the received sound received from the sound collecting microphone M satisfies the predetermined condition, and the volume of such received sound also satisfies the expected volume. Accordingly, since the repetition of the volume searching flight after the sound quality searching flight is suppressed, the output position can be efficiently identified.

In addition, even though the flight (movement) of the flight speaker 1 continues in the sound quality searching flight, the distance between the sound collecting microphone M and the flight speaker 1 does not change from the distance D through the arc-shaped second route R2. Therefore, the sound deterioration of the sound collected by the sound collecting microphone M due to a Doppler effect is suppressed. Accordingly, the sound quality comparison through the sound quality searching flight can be accurately performed.

In addition, the first route R1 in the volume searching flight is formed to be linear, and the second route R2 in the sound quality searching flight is formed in an arc shape. That is, since the first route R1 and the second route R2 are formed in simpler shapes, the first route R1 and the second route R2 can be formed easily, and the volume searching flight and the sound quality searching flight can be started quickly. In the following, the volume searching flight and the sound quality searching flight are generally referred to as “searching flight”.

In the embodiment, through the searching flight based on the received sound from the sound collecting microphone M, the output position at which the flight speaker 1 outputs the ambience sound in the concert hall P1 is identified. Accordingly, prior to the searching flight, it is not required to prepare a model or a map reflecting the shape of the concert hall P1 in which the flight speaker 1 is disposed, the position of the wall or the ceiling, the position of the audience seats, etc. Accordingly, the output position can be adaptively identified in accordance with the space in which the flight speaker 1 is disposed.

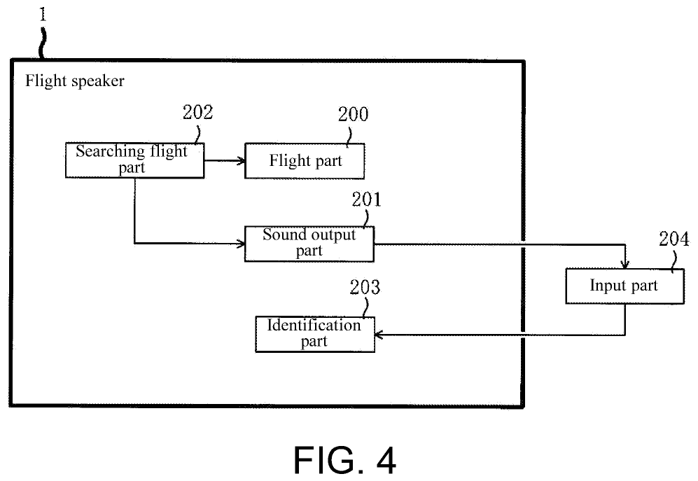

In the following, the function of the flight speaker 1 is described with reference of FIG. 4. FIG. 4 is a functional block diagram of the flight speaker 1. As shown in FIG. 4, the flight speaker 1 has a flight part 200, a sound output part 201, a searching flight part 202, and an identification part 203.

The flight part 200 is realized by using the flight device 2. The sound output part 201 is a part for outputting sounds, and is realized by the speaker 3. The searching flight part 202 is a part for performing the searching flight in which the inspection sound is output from the sound output part 201 while the flight of the predetermined flight route is performed by using the flight part 200, and is realized by using a CPU 10 to be described with reference to FIG. 5.

The identification part 203 is a part for, in a case where it is determined that the sound information at the time of observing, by the input part 204, the inspection sound output during the searching flight using the searching flight part 202 satisfies the predetermined condition, identifying the output position that is a position where the sound is output from the sound output part 201 based on the position in which the inspection sound corresponding to the determination is output, and is realized by the CPU 10. In addition, the input part 204 is realized by the sound collecting microphone M.

In the case where the sound information at the time of observing, by using the input part at the predetermined position, the inspection sound output during the searching flight satisfies the predetermined condition, the output position where the sound is output is identified based on the position where the inspection sound corresponding to the determination is output. That is, at the time of identifying the output position of the flight speaker 1, it is not required to prepare in advance a model or a map of the space in which the flight speaker 1 is disposed . Accordingly, the output position can be adaptively identified in accordance with the space in which the flight speaker is disposed.

Then, the electrical configuration of the flight speaker 1 and the electronic musical instrument 30 is described with reference to FIG. 5. FIG. 5 is a block diagram illustrating the electrical configuration of the flight speaker 1 and the electronic musical instrument 30.

Firstly, the electrical configuration of the flight speaker 1 is described. The flight speaker 1 includes the CPU 10, a flash ROM 11, and a RAM 12 that are respectively connected with an input/output port 14 via a bus line 13. The input/output port 14 is further connected with the flight device 2, the speaker 3, the wireless communication device 4, and the distance sensor 5.

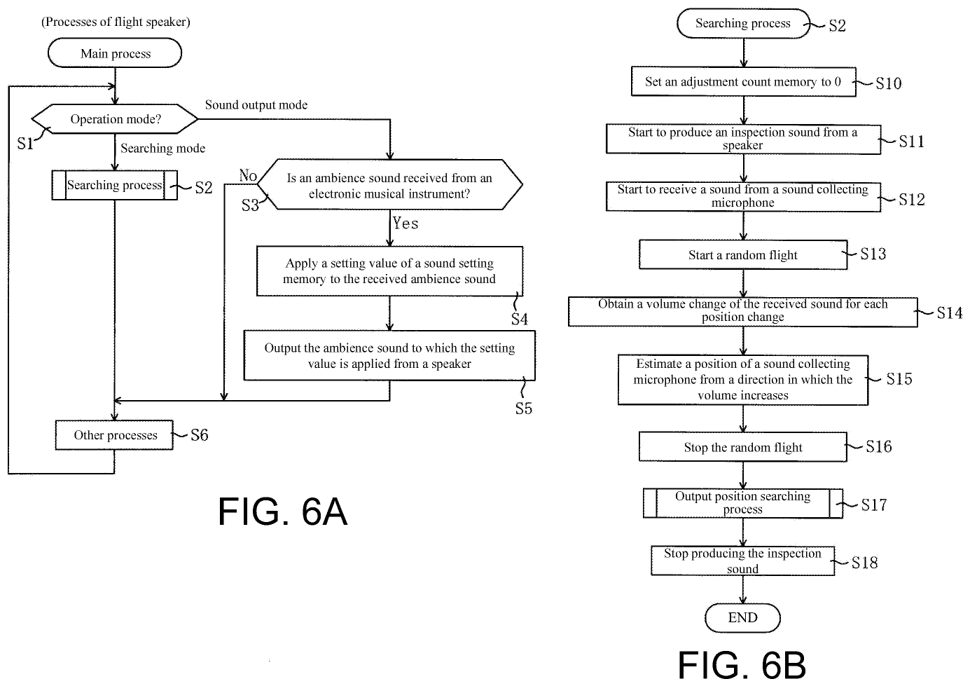

The CPU 10 is a computation device controlling the respective parts connected through the bus line 13. The flash ROM 11 is a rewritable non-volatile memory storing a program executed by the CPU 10 and fixed-value data, etc., and includes a control program 11a, an expected volume memory 11b storing the expected volume, and an expected sound waveform memory 11c storing the expected sound waveform. When the control program 11a is executed by the CPU 10, a main process as shown in FIG. 6A is executed.

The RAM 12 is a memory rewritably storing various work data, flags, etc., at the time of executing the control program 11a, and includes an adjustment count memory 12a storing the number of times that the sound quality searching flight is performed and a sound setting memory 12b storing a sound setting value applied to the speaker 3. The sound setting value stored in the sound setting memory 12b includes the volume of the sound output by the speaker 3, a frequency of the equalizer related to sound quality, a Q width (quality factor), and a gain, and may also include other parameters.

Firstly, the electrical configuration of the electronic musical instrument 30 is described. The electronic musical instrument 30 includes a CPU 31, a flash ROM 32, a RAM 33, a wireless communication device 34, a keyboard 35, a sound source 36, and a digital signal processor (referred to as “DSP” in the following) 37 that are respectively connected via a bus line 38. The CPU 31 is a computation device controlling the respective parts connected through the bus line 15.

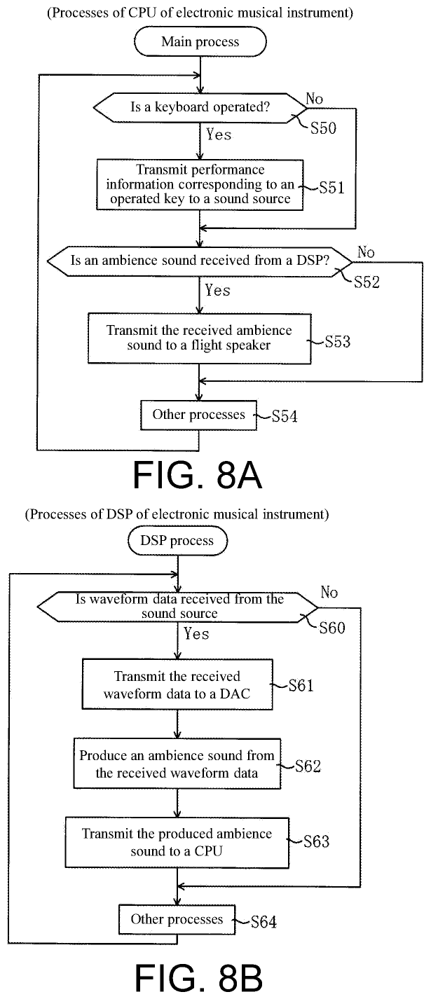

The flash ROM 32 is a rewritable non-volatile memory storing a program executed by the CPU 31 and fixed-value data, etc., and includes a control program 32a. When the control program 32a is executed by the CPU 31, a main process as shown in FIG. 8A is executed. The RAM 33 is a memory rewritably storing various work data, flags, etc., at the time when the CPU 31 executes the program.

The wireless communication device 34 is a device performing wireless communication with an external machine. The ambience sound produced by the electronic musical instrument 30 is transmitted to the flight speaker 1 via the wireless communication device 34. The keyboard 35 has multiple keys and is an input device that obtains performance information through the user's performance. The sound source 36 is a device outputting waveform data based on the performance information input from the keyboard 35.

The DSP 37 is an arithmetic device performing an arithmetic process on the waveform data input from the sound source 36. While details will be described afterwards, the ambience sound is produced by the DSP 37 from the waveform data input from the sound source 36. The DSP 37 is connected with a digital-analog converter (DAC) 39, the DAC 39 is connected with an amplifier 40, and a speaker 41 is connected with the amplifier 40.

Then, with reference to FIGS. 6A and 6B, FIG. 7, and FIGS. 8A and 8B, the processes respectively executed by the flight speaker 1 and the electronic musical instrument 30 are described. Firstly, the process of the flight speaker 1 is described with reference to FIGS. 6A and 6B.

FIG. 6A is a flowchart of the main process of the flight speaker 1. The main process of the flight speaker 1 is a process executed by the CPU 10 after the power of the flight speaker 1 is turned on. In the main process of the flight speaker 1, an operation mode set by the user via a setting button (not shown) of the flight speaker 1 is verified (S1). As the operation mode of the flight speaker 1 in the embodiment, a searching mode performing the searching flight and a sound output mode outputting the ambience sound received from the electronic musical instrument 30 are provided.

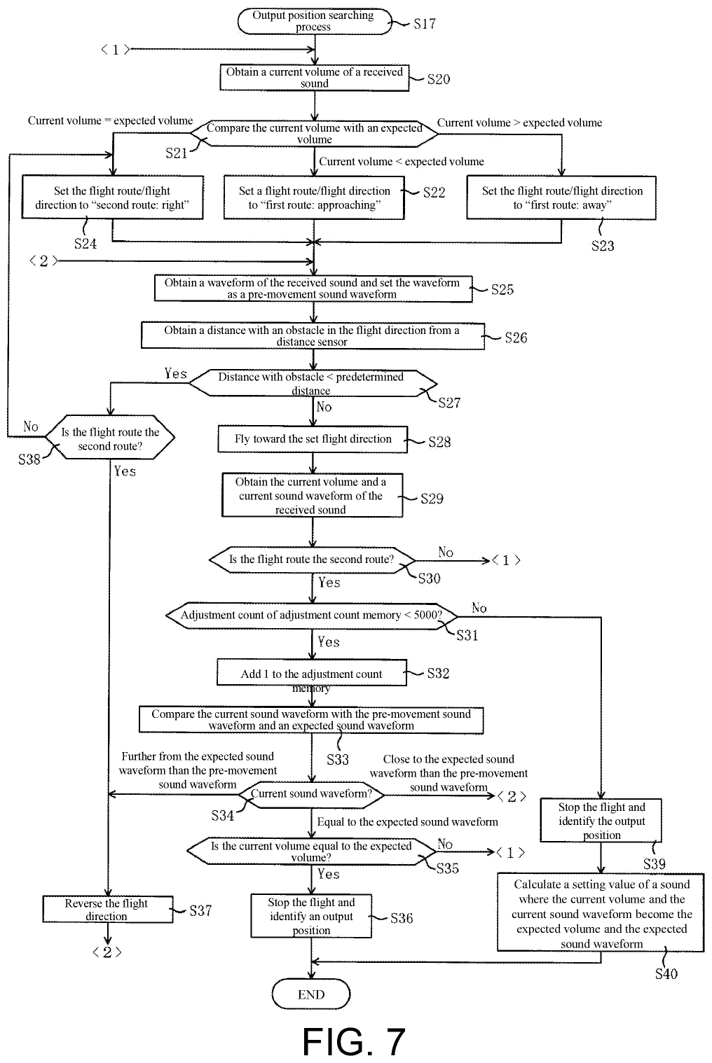

In the process of S1, in the case where the operation mode of the flight speaker 1 is the searching mode (S1: “searching mode”), a searching process of S2 is executed. The searching process of S2 will be described afterwards with reference to FIG. 6B and FIG. 7. Meanwhile, in the case where the operation mode of the flight speaker 1 is the sound output mode (S1: “Sound output mode”), whether the ambience sound is received from the electronic musical instrument 30 via the wireless communication device 4 is verified (S3).

In the process of S3, in the case where the ambience sound is received (S3: YES), by applying the setting value of the sound setting memory 12b to the received ambience sound, the ambience sound is adjusted (S4). After the process of S4, the ambience sound to which the setting value of the sound setting memory 12b is applied in the process of S3 is output from the speaker 3 (S5).

After the searching process of S2, after the process of S5, or in the case where the ambience sound is not received in the process of S3 (S3: NO), another process (S6) of the flight speaker 1 is executed, and the processes since S1 are repeated.

Here, the searching process of S2 is described with reference to FIG. 6B and FIG. 7. FIG. 6B is a flowchart of the searching process. In the searching process, firstly, 0 is set in the adjustment count memory 12a. After the process of S10, the production of the inspection sound from the speaker 3 is started (S11). After the process of S11, the reception of the sound from the sound collecting microphone M via the wireless communication device 4 is started (S12). After the process of S12, the random flight of the flight speaker 1 is started (S13). After the process of S13, the change of the volume of the received sound from the sound collecting microphone M is obtained for each position change due to the random flight (S14).

After the process of S14, from the combinations of the change of the obtained position and the change of the volume of the received sound, the direction in which the volume of the received sound from the sound collecting microphone increases is extracted, and the position of the sound collecting microphone M from the extracted direction, that is, the input position, is estimated (S15). After the process of S15, the random flight of the flight speaker 1 is stopped (S13).

After the process of S16, an output position searching process (S17) is executed, the production of the inspection sound from the speaker 3 is stopped (S18), and the searching process ends. Here, the output position searching process of S17 is described with reference to FIG. 7.

FIG. 7 is a flowchart illustrating the output position searching process of the flight speaker 1. In the output position searching process, firstly, the volume of the received sound received from the sound collecting microphone M is obtained as the current volume (S20). After the process of S20, the obtained current volume is compared with the expected volume of the expected volume memory 11b (S21).

In the process of S21, in the case where the current volume is lower than the expected volume (S21: “Current volume <expected volume”), the flight route of the flight speaker 1 is set to the first route R1, and the flight direction in the flight route is set to the direction approaching the estimated input position (“First route: approaching” in FIG. 7) (S22). As described above with reference to FIG. 3A, in the first route R1, a route linearly connecting the current position of the flight speaker 1 and the estimated input position when viewed from the top of the concert hall P1 is set. With such first flight route R1, the flight speaker 1 performs the volume searching flight through a linear movement.

In addition, in the process of S21, in the case where the current volume is higher than the expected volume (S21: “Current volume >expected volume”), the flight route is set to the first route R1, and the flight direction is set to the direction leaving the position of the sound collecting microphone M (“First route: away” in FIG. 7) (S23).

Meanwhile, in the process of S21, in the case where the current volume is equal to the expected volume (S21: “Current volume =expected volume”), the flight route is set to the second route R2, and the flight direction is set to the clockwise direction (“Second route: right” in FIG. 7) along the second route R2 (S24). Through the processes of S21, S24, in the case where the flight route is switched from the first route R1 to the second route R2, the position of the flight speaker 1 at such time point is set to the optimal volume position in FIG. 3A.

In addition, regarding the second route R2, as shown in FIG. 3B, an arc-shaped route when viewed from the top of the concert hall P1 is set. In the arc-shaped route, the position of the sound collecting microphone M is set as the center and the distance D between the estimated input position and the optimal volume position identified in the volume searching flight executed prior to the process of S24 is set as the diameter. As shown in FIG. 3B, regarding the distance D, the distance with the sound collecting microphone M obtained by the distance sensor 5 at the time when the flight speaker 1 is disposed at the optimal volume position is used. With such second flight route R2, the flight speaker 1 performs the sound quality searching flight through an arc-shaped movement based on the distance D.

In the case where the first route R1 is set as the flight route through the processes of S22, S23, the volume searching flight described in FIG. 3A is performed. In addition, in the case where the second route R2 is set as the flight route through the process of S24, the sound quality searching flight described in FIG. 3B is performed. In the following, in the output position searching process, the volume searching process is performed in the case where the first route R1 is set as the flight route, and the sound quality searching process is performed in the case where the second route R2 is set as the flight route.

After the processes of S22 to S24, the waveform of the received sound received from the sound collecting microphone M is obtained and set as a pre-movement sound waveform (S25). By switching the flight route/flight direction through the processes of S22 to 24, the waveform of the received sound from the sound collecting microphone M at such time point is set as the pre-movement sound waveform and used in a comparison process of S33 to be described afterwards.

After the process of S25, the distance of an obstacle closest to the flight speaker 1 and present in the flight direction from the distance sensor 5 is obtained (S26). After the process of S26, whether the obtained distance with the obstacle is shorter than a predetermined distance (e.g., 1.0 m) is verified (S27). In the process of S27, in the case where the distance with the obstacle is equal to or greater than the predetermined distance (S27: NO), the flight toward the flight direction that is set is performed by using the flight device (S28). Specifically, the orientations of the propellers 2b and the rotation output of the propellers 2b of the flight device 2 for flying toward the flight route and the flight direction that are set are calculated, and the propellers 2b are driven by using the calculated orientations and rotation output. As shown in FIGS. 3A and 3B, the flight direction at this time is adjusted by utilizing the direction of the sound collecting microphone M detected by the distance sensor 5.

After the process of S28, the volume and the waveform of the received sound received from the sound collecting microphone M are obtained as the current volume and the current sound waveform, respectively (S29). Since the flight in the flight route/flight direction switched through the processes of S22 to S24 is started through the process of S28, the volume and the waveform of the sound collected by the sound collecting microphone M at this time are obtained as the current volume and the current sound waveform, respectively.

After the process of S29, whether the current flight route is the second route R2 is verified (S30). In the process of S30, in the case where the current flight route is the first flight route R1 (S30: NO), the processes since S20 are executed. Accordingly, the volume searching flight through the first route R1 is continued. Meanwhile, in the process of S30, in the case where the current flight route is the second route R2 (S30: YES), whether the adjustment count of the adjustment count memory 12a is less than 5000 is verified (S31).

Here, the value “5000” compared with the adjustment count of the adjustment count memory 12a in the process of S31 is set based on the time required for the flight speaker 1 to complete two rounds of the second path R2, but the value may also be equal to or greater than 5000 or equal or less than 5000.

In the process of S31, in the case where the adjustment count of the adjustment count memory 12a is less than 5000 (S31: YES), the current sound waveform obtained in the process of S29, the pre-movement sound waveform obtained in the process of S25 and the expected sound waveform of the expected sound waveform memory 11c are compared (S32).

Regarding the process of S32, specifically, a first waveform obtained by subtracting the expected sound waveform from the pre-movement sound waveform and a second waveform obtained by subtracting the expected sound waveform from the current sound waveform are respectively calculated. In addition, the first waveform and the second waveform are compared. In this way, by comparing the pre-movement sound waveform and the current sound waveform by using the expected sound waveform as the reference, whether the current sound waveform is equal to the expected sound waveform, whether the current sound waveform is closer to the expected sound waveform than the pre-movement sound waveform, or whether the current sound waveform is further away from the expected sound waveform than the pre-movement sound waveform can be determined.

After the process of S32, the process result through the process of S32 is verified (S34). In the process of S34, in the case where the current sound waveform is equal to the expected sound waveform (S34: “equal to expected sound waveform”), whether the current volume is equal to the expected volume of the expected volume memory 11b is verified. In the process of S35, in the case where the current volume is equal to the expected volume of the expected volume memory 11b (S35: YES), the flight is stopped, and the position where the current volume is equal to the expected volume of the expected volume memory 11b is identified as the output position (S36).

Meanwhile, in the process of S35, in the case where the current volume is not equal to the expected volume of the expected volume memory 11b (S35: NO), the processes since S20 are repeated. That is, although the position where the current sound waveform is equal to the expected sound waveform can be identified through the sound quality searching flight after the optimal volume position is identified through the volume searching flight, the volume at such position may not be equal to the volume of the optimal volume position if there is an obstacle present between such position and the position of the sound collecting microphone M. Therefore, in the case where the current volume is not equal to the expected volume of the expected volume memory 11b, the output position of the flight speaker 1 where a sound with the appropriate volume and sound quality in the sound collecting microphone M can be obtained can be identified by redoing the processes since S20, that is, from the volume searching flight.

In the process of S34, in the case where the current sound waveform is closer to the expected sound waveform than the pre-movement sound waveform (S34: “closer to the expected sound waveform than the pre-movement sound waveform”), even though the current sound waveform is not equal to the expected sound waveform, the sound quality searching flight needs to continue since the current sound waveform is closer to the expected sound waveform than the pre-movement sound waveform. In such case, the sound quality searching flight continues by repeating the processes since S25.

In addition, in the process of S34, in the case where the current sound waveform is further away from the expected sound waveform than the pre-movement sound waveform (S34: “further from the expected sound waveform than the pre-movement sound waveform”), the pre-movement sound waveform is closer to the expected sound waveform than the current sound waveform, and it is necessary to fly the flying speaker 1 so that the position of the flight speaker 1 returns to the position where the pre-movement sound waveform is received. In such case, by reversing the flight direction (S37) and repeating the processes since S25, the flight is switched to the sound quality searching flight toward the direction of the position where the pre-movement sound waveform is received.

“reversing the flight direction” in the process of S37 refers to flying along the second route R2 in the counter-clockwise direction the case of flying along the second route R2 in the clockwise direction, or flying along the second route R2 in the clockwise direction the case of flying along the second route R2 in the counter-clockwise direction.

In the process of S27, in the case where the distance with the obstacle is shorter than the predetermined distance (S27: YES), whether the flight route is the second route R2 is verified (S38). In the process of S38, in the case where the flight route is the second route R2 (S38: YES), the process of S37 is executed, and the flight direction is reversed. Meanwhile, in the process of S38, in the case where the flight route is the first route R1 (S38: NO), the processes since S22 are executed, the flight route is set as the second route R2, and the sound quality searching flight in which the flight direction is set as the clockwise direction in the arc-shaped second route R2 is performed.

That is, at the time of the sound quality searching flight (S38: the case of YES), in the case where the distance with the obstacle is equal to or shorter than the predetermined distance, an obstacle is present on the arc-shaped second route R2. In such case, by reversing the flight direction, the sound quality searching flight can continue, while the contact with the obstacle can be suppressed.

Meanwhile, at the time of the volume searching flight (S38: the case of NO), in the case where the distance with an obstacle is equal to or shorter than the predetermined distance, the flight of further approaching the position of the sound collecting microphone M on the linear first route R1 or further continuing the flight of leaving the position of the sound collecting microphone M is not possible. In such case, by switching from the volume searching flight to the sound quality searching flight, the situation in which the output position cannot be identified due to the approaching toward the obstacle can be suppressed.

Meanwhile, in such case of switching from the volume searching flight to the sound quality searching flight because of the approaching of the flight speaker 1 toward the obstacle, even though there is a case where the current volume is not the expected volume, in such case, in the process of S35, it is determined that the current volume is not equal to the expected volume and the processes since S20 are executed again, thereby performing the volume searching flight again.

In the process of S31, the case where the adjustment count of the adjustment count memory 12a is equal to or greater than 5000 (S31: NO) is the case where a predetermined period has passed since the sound quality searching flight is searched, and is the case where the position of the flight speaker 1 where the current sound waveform is not equal to the expected sound waveform cannot be found even if the sound quality searching flight is performed further. In such case, the flight is stopped, and such position is identified as the output position (S39). After the process of S39, the setting value (i.e., the volume, the frequency of the equalizer, the Q width, and the gain) of the sound in which the current volume and the current sound waveform become the expected volume and the expected sound waveform is calculated (adjusted) and stored in the sound setting memory 12b (S40).

That is, in the case where the adjustment count of the adjustment count memory 12a is equal to or greater than 5000, by setting such position as a temporary output position, the situation in which the output position cannot be identified for a long time and the ambience sound cannot be output. In addition, at the output position that is temporarily identified, by setting the setting value of the sound in which the current volume and the current sound waveform become the expected volume and the expected sound waveform, the ambience sound output at such output position can be appropriately heard at the position of the sound collecting microphone M.

After the processes of S36, S40, the output position searching process is ended.

Next, with reference to FIGS. 8A and 8B, the processes executed by the electronic musical instrument 30 are described. FIG. 8A is a flowchart of the main process of the electronic musical instrument 30. The main process of the electronic musical instrument 30 is a process executed by the CPU 31 after the power of the electronic musical instrument 30 is turned on.

In the main process of the electronic musical instrument 30, firstly, whether the keyboard 35 is operated is verified (S50). In the process of S50, in the case where the keyboard 35 is operated (S50: YES), the performance information of the key that is operated in the keyboard 35 is transmitted to the sound source 36 (S51). Accordingly, the sound source 36 transmits the waveform data corresponding to the received performance information to the DSP 37. Here, the process of the DSP 37 is described with reference to FIG. 8B.

FIG. 8B is a flowchart of the DSP process of the electronic musical instrument 30. The DSP process is a process executed by the DSP 37 after the power of the electronic musical instrument 30 is turned on. In the DSP process, firstly, whether the waveform data is received from the sound source 36 is received is verified (S60). In the process of S60, in the case where the waveform data is received from the sound source 36 (S60: YES), the received waveform data is transmitted to the DAC 39 (S61). The waveform data transmitted to the DAC 39 is output, as a musical sound, via the amplifier 40 and the speaker 41.

After the process of S61, the ambience sound is produced from the waveform data from the sound source 36 (S62). Specifically, as described above, the reverberation component and the specific frequency component are extracted from the waveform data, and the ambience sound is produced from the extracted sound components. After the process of S62, the produced ambience sound is transmitted to the CPU 31 (S63).

Meanwhile, in the process of S60, in the case where the waveform data is not received from the sound source 36 (S60: NO), the processes of S61 to S63 are skipped. After the processes of S60, S63, another process of the DSP 37 is executed (S64), and the processes since S60 are repeated.

Referring to FIG. 8A again, in the process of S50, in the case where the keyboard 35 is not operated (S50: NO), the process of S51 is skipped. After the processes of S50, S51, whether the ambience sound is received from the DSP 37 is verified (S52). In the process of S52, in the case where the ambience sound is received from the DSP 37 (S52: YES), the received ambience sound is transmitted to the flight speaker 1 via the wireless communication device 34.

Meanwhile, in the process of S52, in the case where the ambience sound is not received from the DSP 37 (S52: NO), the process of S53 is skipped. After the processes of S52, S53, another process of the electronic musical instrument 30 is executed (S54), and the processes since S50 are repeated.

Although the invention is described based on the embodiment, it can be easily understood that various modifications and improvements are possible.

In the embodiment, although the flight route of the volume searching flight is set as the first route R1 in which the current position of the flight speaker 1 and the estimated input position are connected linearly, the invention is not limited thereto. For example, the flight route of the volume searching flight may be a zigzag route connecting the current position and the input position, and may also be a curved route connecting the current position and the input position. In addition, the flight route of the volume searching flight may be arc-shaped like the sound quality searching flight, and may also be polygon-shaped, such as being rectangular.

In addition, although the first route R1 is a route connecting the current position and the input position, the invention is not limited thereto. For example, the first route R1 may also be a route connecting the current position and an arbitrary position (e.g., the position of the electronic musical instrument 30) in the concert hall P1.

Although the flight route of the sound quality searching flight is set as the second route R2 in an arc shape in which the estimated input position is set as the center, and the distance D between such input position and the optimal volume position identified in the volume searching flight is set as the diameter, the invention is not limited thereto. For example, the flight route of the sound quality searching flight is set to be in a polygon-shape, such as a rectangular shape, in which the input position is set as the center, and the optimal volume position is set as the initial position. In addition, the flight route of the sound quality searching flight may be set to be linear, like the volume searching flight, and may also be set to be zigzag.

In addition, although the second route R2 is set with the estimated input position as the center and the distance D between the input position and the optimal volume position identified in the volume searching flight as the diameter, the invention is not limited thereto. For example, the center of the second route R2 may also be set at an arbitrary position (e.g., the position of the electronic musical instrument 30) in the concert hall P1. In addition, the diameter of the second route R2 may also be longer or shorter than the distance D.

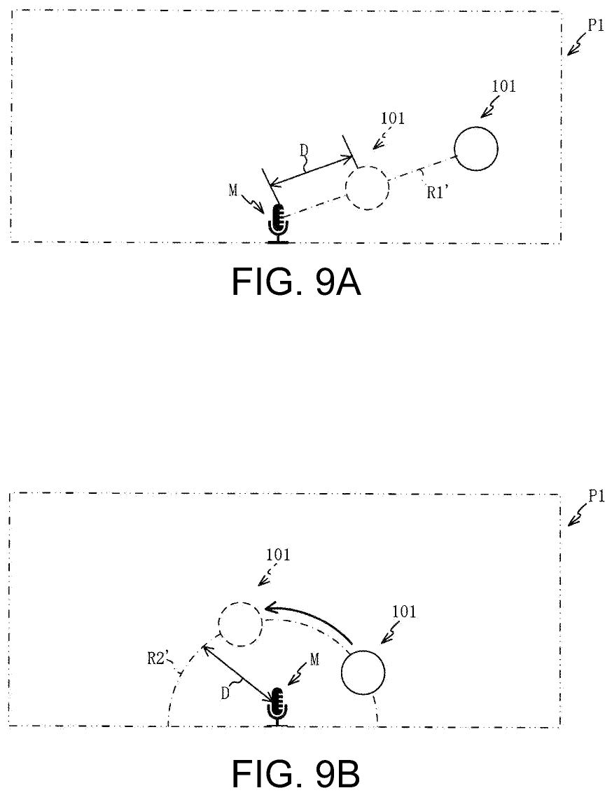

In the embodiment, the flight route of the volume searching flight is set as the first route R1 that is linear when observed from the top of the concert hall P1. However, the invention is not limited thereto. For example, as shown in a flight speaker 101 in FIG. 9A, the flight route of the volume searching flight may also be set as a first route R1′ that is linear when observed from a side surface of the concert hall P1.

Likewise, although the flight route of the sound quality searching flight is set as the second route R2 that is arc-shaped when viewed from the top of the concert hall P1, the invention is not limited thereto. For example, as shown in the flight speaker 101 in FIG. 9B, the flight route of the sound quality searching flight may also be set as a second route R2′ that is arc-shaped when observed from a side surface of the concert hall P1.

In addition, in the case where the flight route of the sound quality searching flight is set in a shape different from the arc shape, the deterioration of the sound may occur due to a Doppler effect in the received sound of the sound collecting microphone M in correspondence with the position of the flight speaker 101 outputting the inspection sound. However, in such case, the received sound may be modulated in correspondence with the distance between the flight speaker 101 and the sound collecting microphone M, that is, in correspondence with the frequency change due to the Doppler effect.

In addition, it may also be that the flight route of the volume searching flight is set as the first route R1′ and the flight route of the subsequent sound quality searching flight is set as the second route R2, and it may also be that the flight route of the volume searching flight is set as the first route R1 and the flight route of the subsequent sound quality searching flight is set as the second route R2′.

In the embodiment, the optimal volume position is identified through the volume searching flight, and then the output position is identified through the sound quality searching flight. However, the invention is not limited thereto. For example, it may also be that the optimal volume position identified in the volume searching flight is directly identified as the output position, and the sound quality searching flight is omitted. In such case, the fly speaker 1 may further arranged to fly through the user's manual operation to a position where the sound waveform of the received sound from the sound collecting microphone M is equal to the expected sound waveform. Likewise, it may also be that the volume searching flight is omitted, and the sound quality searching flight is performed by the flight speaker 1 after the flight speaker 1 is disposed at the optimal volume position through the user's manual operation.

In addition, the volume searching flight and the sound quality searching flight may also be performed simultaneously. In such case, the volume searching flight and the sound quality searching flight may be performed simultaneously by searching for a position at which the volume of the received sound from the sound collecting microphone M satisfies the expected volume and the sound waveform of the received sound satisfies the sound waveform. At this time, it may be that whether the volume and the sound quality of the received sound respectively satisfy the expected volume and the expected sound quality is verified while performing a linear movement like the volume searching flight, and it may also be that whether the volume and the sound quality of the received sound respectively satisfy the expected volume and the expected sound quality is verified while performing an arc-shaped movement like the sound quality searching flight. Also, in the case where the linear movement like the volume searching flight is firstly performed, whether the volume and the sound quality of the received sound respectively satisfy the expected volume and the expected sound quality is verified, and only the volume of the received sound satisfies the expected volume, the flight may also be switched to the arc-shaped movement like the sound quality searching flight.

According to the embodiment, in the process of S31 of FIG. 7, in the case where the adjustment count is equal to or greater than 5000, the position is identified as the output position, and the setting value of the sound setting memory 12b is set. However, the invention is not limited thereto. For example, it may also be that, in the case where the adjustment count is equal to or greater than 5000, the position where the volume and the sound quality of the received sound of the sound collecting microphone M are most approximate to the expected volume and the expected sound quality in the searching flight so far is identified as the output position, and the setting value of the sound setting memory 12b is set.

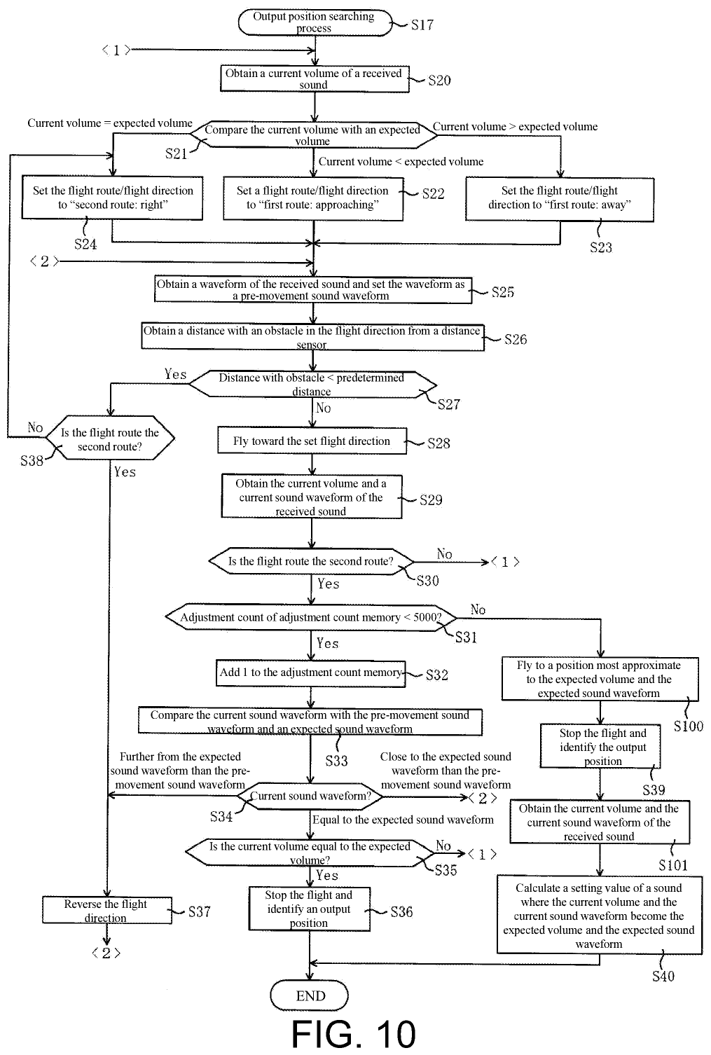

Specifically, like an output position searching process of FIG. 10, in the case where the adjustment count of the adjustment count memory 12a is equal to or greater than 5000 (S31: NO), in the searching flight, the flight speaker flies to a position (referred to as “approximate position” in the following) where the volume and the sound quality of the received sound of the sound collecting microphone M are most approximate to the expected volume and the expected sound quality (S100). As an example, a means for flying to the approximate position through the process of S100 includes that, in the case where the approximate position is identified, the rotation output of the propellers 2b and the orientations of the propellers 2b are stored in order in the subsequent flight, and the rotation output of the propellers 2b and the orientations of the propellers 2b that are stored are reproduced by the propellers 2b in an order opposite to the stored order, thereby flying to the approximate position.

After the process of S100, the process of S39 is executed and the flight is stopped. After the process of S39, in order to obtain the current volume and the current sound waveform at the approximate position moved in the processes of S100, S39, the volume and the waveform of the received sound received from the sound collecting microphone M are obtained as the current volume and the current sound waveform, respectively (S101). After the process of S101, the process of S40 is executed, and the appropriate sound setting value at the approximate position is set in the sound setting memory 12b.

In this way, in the case where the adjustment count is equal to or greater than 5000, the approximate position at which the volume and the sound quality of the received sound of the sound collecting microphone M are approximate to the expected volume and the expected sound quality is set as the temporary output position. Accordingly, since the variation amount (adjustment amount) of the sound setting value set in the sound setting memory 12b at such output position can be smaller than other positions, the sound deterioration can be suppressed in the case where such sound setting value is applied to the ambience sound. Accordingly, the ambience sound output at the output position can be heard at an appropriate volume and sound quality at the position of the sound collecting microphone M.

In the embodiment, the sound setting value through the process of S40 of FIG. 7 is set based on the expected volume and the expected sound waveform. However, the invention is not limited thereto. For example, in the process of S40, the sound setting value may be set so as to achieve a volume or sound waveform desired by the user. In addition, the setting of the sound setting value achieving the volume or sound waveform desired by the user may also be performed in the case where the output position is identified through the process of S36.

In the embodiment, in FIGS. 3A and 3B and FIG. 7, the received sound from the sound

collecting microphone M is directly used for comparison with the expected volume and the expected sound waveform. However, the invention is not limited thereto. For example, it may also be that noise, such as the operation sounds of the propellers 2b, the sound of the audience in the concert hall P1, is removed from the received sound, and then the comparison with the expected volume and the expected sound waveform is performed. As an example of a means in such case, an adaptive filter and a deconvolution arithmetic operation using the correlation with the inspection sound output from the speaker 3 are exemplified.

In the embodiment, in FIG. 7, the comparison between the received sound from the sound collecting microphone M and the expected volume and the expected sound waveform is performed, while the flight of the flight speaker 1 along the flight route through the process of S28 continues. However, the invention is not limited thereto. For example, it may also be that the propellers 2b of the flight device 2 is driven to fly for a predetermined distance (e.g., 0.3 m) or a predetermined time (e.g., within 5 seconds) through the process of S28, and then the propellers 2b are stopped to stop the flight speaker 1, and then the processes since S29 are performed. Accordingly, since the driving sounds of the propellers 2b can be suppressed from being mixed with the received sound from the sound collecting microphone M, the comparison between the received sound and the expected volume and the expected sound waveform can be performed accurately.

In the embodiment, in FIG. 6A, the ambience sound is output in the case where the operation mode of the flight speaker 1 is the sound output mode. However, the invention is not limited thereto. For example, in the case where the operation mode is the sound output mode, the musical sound output from the electronic musical instrument 30 may be output, acoustic effect sounds recorded in advance, such as human cheers and cries of animals (e.g., cats), may be output, and other sounds may also be output.

In addition, the ambience sound is formed by the reverberation component and a specific frequency component in the musical sound output by the electronic musical instrument 30. However, the invention is not limited thereto. For example, the ambience sound may also be formed by the reverberation component only or by the specific frequency component only. In addition, sounds in which the acoustic effect sounds or other sounds are added to to the reverberation component and the specific frequency component may be adopted as the ambience sounds, and sounds in which acoustic effects (effects), such as distortion, are added to the reverberation component and the specific frequency component may also be adopted as the ambience sound.

In the embodiment, when the ambience sound is received from the electronic musical instrument 30 in the case of the sound output mode, the received ambience sound is output. However, the invention is not limited thereto. For example, such ambience sound may also be output after a predetermined time (e.g., after 50 milliseconds) after the ambience sound is received from the electronic musical instrument 30. Alternatively, it may also be that, at the time of receiving the ambience sound from the electronic musical instrument 30, the time at which the ambience sound is output is received at the same time with the ambience sound, and in the case where the current time reaches the received time, the received ambience sound is output.

In this way, with the configuration that the timing at which the ambience sound is output is variable, it is possible to suppress the situation in which the output timing of the ambience sound is too early and the ambience sound is drowned out in the musical sound output from the electronic musical instrument 30, or, on the contrary, the situation in which the output timing of the ambience sound is too late, and the listener feels discomfort.

In the above embodiment, in the processes of S4, S5 of FIG. 6A, by applying the sound setting value of the sound setting memory 12b to the ambience sound, the sound setting value set in the process of S40 of FIG. 7 is reflected in the ambience sound. However, the invention is not limited thereto. For example, the sound setting value of the sound setting memory 12b may also be reflected in the output setting of the speaker 3. Accordingly, the sound setting value set in the process of S40 of FIG. 7 can be reflected in the output ambience sound without the ambience sound itself being processed.

In the embodiment, white noise is used as the inspection sound in the searching flight. However, the invention is not limited thereto. For example, as the inspection sound, a sine wave, a sawtooth wave, a rectangular wave may be used, and an ambience sound may also be used.

In the embodiment, the ambience sound is produced by the DSP 37 of the electronic musical instrument 30. However, the invention is not limited thereto. The ambience sound may also be produced by the CPU 10 of the electronic musical instrument 30. In addition, the ambience sound is produced by the ambience speaker 1. In such case, it may also be that the electronic musical instrument 30 transmits the waveform data obtained from the sound source 36 to the flight speaker 1, and the flight speaker 1 produces the ambience sound from the received waveform data through a process same as S62 of FIG. 8.

In the embodiment, in the sound quality searching flight, the output position is identified by comparing the sound waveform of the received sound from the sound collecting microphone M and the sound waveform of the expected sound waveform memory 11c. However, the invention is not limited thereto. For example, it may also be that a frequency spectrum of the sound waveform of the received sound from the sound collecting microphone is obtained, and such frequency spectrum is compared with the frequency spectrum (referred to as “expected frequency spectrum” in the following) of the sound waveform collected by the sound collecting microphone M that is expected and set in advance. At this time, in place of the expected sound waveform memory 11c, the flash ROM 11 stores the expected frequency spectrum. Also, in addition to the frequency spectrum, the output position may also be identified by using the distortion rate or the reverberation time of the received sound.

In the embodiment, the volume and the sound waveform of the received sound from the sound collecting microphone M are obtained by using the flight speaker 1. However, the invention is not limited thereto. It may also be that the volume and the sound waveform of the collected sound are obtained in the sound collecting microphone M, and the obtained volume and sound waveform are transmitted to the flight speaker 1.

In addition, it may also be that, in the sound collecting microphone M, the comparison between the obtained volume and the expected volume is performed, the comparison result is transmitted to the flight speaker 1, and the processes of S21, S35 of the flight speaker 1 in FIG. 7 are performed based on the comparison result received from the sound collecting microphone M. Similarly, it may also be that, in the sound collecting microphone M, the comparison between the obtained sound waveform and the expected sound waveform is performed, the comparison result is transmitted to the flight speaker 1, and the process of S34 of the flight speaker 1 in FIG. 7 is performed based on the comparison result received from the sound collecting microphone M.

In the embodiment, one flight speaker 1 is disposed in the concert hall P1. However, the invention is not limited thereto. Two or more flight speakers 1 may also be disposed. In this case, it may also be that the two or more flight speakers 1 perform the searching flights at the same time and identify the respective output positions, and it may also be that the two or more flight speakers 1 perform the searching flights one after another.

In the case where the two or more flight speakers 1 perform the searching flights at the same time, the flight speakers 1 may approach each other. In such case, the other flight speaker 1 is determined as an obstacle through the process of S27 of FIG. 7, the volume searching flight is changed into a volume flight route through the processes of S24, S39, and the flight route of the volume flight route is reversed. Therefore, the flight speakers 1 can be respectively disposed at appropriate output positions without contacting the flight speakers 1.

In the embodiment, the input position (the position of the sound collecting microphone M) is estimated through the processes of S13 to S16 in FIG. 6B. However, the invention is not limited thereto. For example, the position of the sound collecting microphone M may also be set in advance in the flight speaker 1, and the processes of S13 to S16 may be omitted.

In addition, although the output searching process of S17 is performed after the processes of estimating the input position of S14, S15, the invention is not limited thereto. The processes of S14, S15 may also be executed in parallel during the flight in the output searching process of S17. Accordingly, since the process of estimating the input position is performed over a long period of time, the accuracy of the estimated input position can be facilitated.

In the embodiment, in FIG. 3, the distance sensor 5 is provided in the flight speaker 1 and an identification marker is attached to the sound collecting microphone M to obtain the distance from the flight speaker 1 to the sound collecting microphone M and the direction of the sound collecting microphone M when observed from the flight speaker 1. However, the invention is not limited thereto. For example, it may also be that the distance sensor is provided in the sound collecting microphone M, and the identification marker is attached to the flight speaker 1. In such case, the distance to the flight speaker 1 obtained by the distance sensor of the sound collecting microphone M and the direction when observed from the distance sensor may be transmitted to the flight speaker 1 through wireless communication, and the transmitted position and direction may be converted by the flight speaker 1, thereby obtaining the distance of the sound collecting microphone M from the flight speaker 1 and the direction of the sound collecting microphone M when observed from the flight speaker 1.

In addition, the distance of the sound collecting microphone M from the flight speaker 1 and the direction of the sound collecting microphone M when observed from the flight speaker 1 are obtained by the distance sensor 5. However, the invention is not limited thereto. For example, it may also be that a global navigation satellite system (GNSS) reception device or a quasi-Zenith satellite system (QZSS) reception device is provided in each of the flight speaker 1 and the sound collecting microphone M, and the distance of the sound collecting microphone M from the flight speaker 1 and the direction of the sound collecting microphone M when observed from the flight speaker 1 are obtained from the respective position information (latitude, longitude and height) of the flight speaker 1 and the sound collecting microphone M received by the GNSS reception device, etc.

In the embodiment, the flight device 2 is formed by a silent drone. However, the invention is not limited thereto. The flight device 2 may also be formed by only the drone, excluding the balloon 2a removed from the silent drone, and may also be formed by a balloon, or formed by other flight devices.

In the embodiment, the flight speaker 1 is disposed in the concert hall P1. However, the invention is not limited thereto. For example, the flight speaker 1 may also be disposed in other indoor facilities, such as a gym, a classroom, an auditorium, etc., and may also be disposed outdoor in a park, a track and field stadium, and an outdoor live venue, etc.

In the embodiment, the flight speaker 1 is shown. However, the invention is not limited thereto. For example, the control program 11a may also be arranged to be executable by an information processing device, such as a personal computer, a mobile terminal. In such case, the flight device 2 and the speaker 3 may be connected with the information processing device, such as a personal computer.

What is claimed is:

1. A flight speaker, comprising:
a flight part;
a sound output part, outputting a sound;
a searching flight part, performing a searching flight in which an inspection sound is output from the sound output part while performing a flight of a predetermined flight route using the flight part; and
an identification part, in a case where a determination is made that sound information at a time of observing, by using an input part disposed at a predetermined position, the inspection sound output in the searching flight using the searching flight part satisfies a predetermined condition, identifying an output position that is a position where the sound is output from the sound output part based on a position where the inspection sound corresponding to the determination is output.

2. The flight speaker as claimed in claim 1, wherein the sound information comprises a volume,
the searching flight part comprises a volume searching flight part performing a volume searching flight, which is the searching flight in which the inspection sound is output from the sound output part, while performing a flight of a first route as a flight route, and
the identification part comprises an optimal volume position identification part which, in a case where a determination is made that a volume at a time of making observation by using the input part during the volume searching flight using the volume searching flight part satisfies a predetermined condition, identifies an optimal volume position that is the position where the inspection sound corresponding to the determination is output, and identifies the output position based on the optimal volume position identified by the optimal volume position identification part.

3. The flight speaker as claimed in claim 1, wherein the sound information comprises a sound quality,
the searching flight part comprises a sound quality searching flight part performing a sound quality searching flight, which is the searching flight in which the inspection sound is output from the sound output part, while performing a flight of a second route as the flight route, and
the identification part comprises an optimal sound quality position identification part which, in a case where a determination is made that a sound quality at a time of making observation by using the input part during the sound quality searching flight using the sound quality searching flight part satisfies a predetermined condition, identifies an optimal sound quality position that is the position where the inspection sound corresponding to the determination is output, and identifies the output position based on the optimal sound quality position identified by the optimal sound quality position identification part.

4. The flight speaker as claimed in claim 2, wherein the sound information comprises the volume and a sound quality,
the searching flight part comprises a sound quality searching flight part performing a sound quality searching flight, which is the searching flight in which the inspection sound is output from the sound output part, while performing a flight of a second route as the flight route based on the optimal volume position identified by the optimal volume position identification part, and
the identification part comprises an optimal sound quality position identification part which, in a case where a determination is made that a sound quality at a time of making observation by using the input part during the sound quality searching flight using the sound quality searching flight part satisfies a predetermined condition, identifies an optimal sound quality position that is the position where the inspection sound corresponding to the determination is output, and identifies the output position based on the optimal sound quality position identified by the optimal sound quality position identification part.

5. The flight speaker as claimed in claim 2, comprising: a preliminary searching flight part, performing the searching flight in which the inspection sound is output from the sound output part while performing a flight using the flight part; and
a position estimation part, estimating an input position that is a position of the input part based on a volume at a time of observing, by using the input part, the inspection sound output in a flight using the preliminary searching flight part,
wherein the first route is a flight route on which a current position of the flight speaker is approaching the input position estimated by the position estimation part or a flight route on which the current position of the flight speaker is leaving the input position.

6. The flight speaker as claimed in claim 5, wherein the first route is formed in a linear shape connecting the current position of the flight speaker and the input position estimated by using the position estimation part.

7. The flight speaker as claimed in claim 4, comprising: a preliminary searching flight part, performing the searching flight in which the inspection sound is output from the sound output part while performing a flight using the flight part; and
a position estimation part, estimating an input position that is a position of the input part based on a volume at a time of observing, by using the input part, the inspection sound output in a flight using the preliminary searching flight part,
wherein the first route is a flight route on which a current position of the flight speaker is approaching the input position estimated by the position estimation part or a flight route on which the current position of the flight speaker is leaving the input position.

8. The flight speaker as claimed in claim 7, wherein the first route is formed in a linear shape connecting the current position of the flight speaker and the input position estimated by using the position estimation part.

9. The flight speaker as claimed in claim 4, comprising: a preliminary searching flight part, performing the searching flight in which the inspection sound is output from the sound output part while performing a flight using the flight part; and
a position estimation part, estimating an input position that is a position of the input part based on a volume at a time of observing, by using the input part, the inspection sound output in a flight using the preliminary searching flight part,
wherein the second route is a flight route based on a distance between the optimal volume position identified by the optimal volume position identification part and the input position estimated by the position estimation part.

10. The flight speaker as claimed in claim 9, wherein the second route is formed in an arc shape in which the input position estimated by the position estimation part is set as a center and the distance between the optimal volume position identified by the optimal volume position identification part and the input position estimated by the position estimation part.

11. The flight speaker as claimed in claim 4, wherein in the sound quality searching flight by using the sound quality searching flight part, in a case where the volume observed by using the input part does not satisfy the predetermined condition, the volume searching flight is performed again by the volume searching flight part.

12. The flight speaker as claimed in claim 9, wherein in the sound quality searching flight by using the sound quality searching flight part, in a case where the volume observed by using the input part does not satisfy the predetermined condition, the volume searching flight is performed again by the volume searching flight part.

13. The flight speaker as claimed in claim 1, wherein in a case where the sound information observed by using the input part does not satisfy the predetermined condition for a predetermined period since the searching flight using the searching flight part starts, the identification part identifies the output position based on a position most approximate to the predetermined condition in the searching flight so far.

14. The flight speaker as claimed in claim 1, wherein in a case where the sound information observed by using the input part does not satisfy the predetermined condition for a predetermined period since the searching flight using the searching flight part starts, the identification part identifies the output position based on a position of the flight speaker at such time point.

15. The flight speaker as claimed in claim 13, comprising an adjustment part adjusting a setting value for outputting a sound in the sound output part, so that the sound information at the time of observing, by using the input part, the inspection sound output by the sound output part satisfies the predetermined condition at the output position identified by the identification part.

16. The flight speaker as claimed in claim 1, comprising:
an obstacle detection part, detecting an obstacle; and
a reversing part, reversing a flight direction in a case where the obstacle detection part detects the obstacle in the flight direction in the searching flight using the searching flight part.

17. The flight speaker as claimed in claim 1, wherein the sound output from the sound output part is an ambience sound comprising a reverberation component in a musical sound output from an electronic musical instrument disposed together with the flight speaker and a specific frequency component of the musical sound.

18. The flight speaker as claimed in claim 1, wherein the flight part is formed by a silent drone comprising a drone and a balloon.

19. An output position identification method, executed by a flight speaker comprising a flight part and a sound output part outputting a sound, the output position identification method comprising:
a searching flight step of performing a searching flight in which an inspection sound is output from the sound output part while performing a flight of a predetermined flight route using the flight part; and
an identification step, in a case where a determination is made that sound information at a time of observing, by using an input part disposed at a predetermined position, the inspection sound output in the searching flight using the searching flight step satisfies a predetermined condition, identifying an output position that is a position where the sound is output from the sound output part based on a position where the inspection sound corresponding to the determination is output.

20. A non-transitory computer readable medium, storing an output position identification program causing a computer comprising a flight part and a sound output part outputting a sound to execute a process for identifying an output position that is a position where the sound is output from the sound output part, the computer being caused to execute:
a searching flight step of performing a searching flight in which an inspection sound is output from the sound output part while performing a flight of a predetermined flight route using the flight part; and
an identification step, in a case where a determination is made that sound information at a time of observing, by using an input part disposed at a predetermined position, the inspection sound output in the searching flight using the searching flight step satisfies a predetermined condition, identifying an output position that is a position where the sound is output from the sound output part based on a position where the inspection sound corresponding to the determination is output.
